(19) United States
(12) Patent Application Publication
(10) Pub. No.: US 2006/0249927 A1
(43) Pub. Date: Nov. 9, 2006

(54) Coupling device for the connecting a tractor engine to a trailer vehicle

(76) Inventors: Heinz-Rüdiger Metternich, Hamburg (DE); Karsten Lüders, (US)

Correspondence Address: MEREK, BLACKMON & VOORHEES, LLC, 673 S. WASHINGTON ST, ALEXANDRIA, VA, 22314, US

(21) Appl. No.: 10/569,823

(22) PCT Filed: Aug. 23, 2004
(86) PCT No.: PCT/EP04/09386

§ 371 Date: Apr. 7, 2006

(30) Foreign Application Priority Data
Aug. 28, 2003 (DE) 203 13 469.9
Feb. 12, 2004 (DE) 20 2004 002252.4

(51) Int. Cl. B60D 1/02

(52) U.S. Cl. 280/515

(57) ABSTRACT

The invention relates to a coupling device for the coupling of a trailer vehicle to a tractor engine, comprising, on the tractor engine, a coupling body (10), with an insertion opening (11) and pneumatically-operated coupling bolt (12) and, on the trailer, a drawbar (20), with a drawbar eye (21), for the passage of the coupling bolt (12). A tubular piece (13) is arranged below the coupling body (10), coaxially rotating about the geometrical axis (Z-axis) of the coupling bolt (12), at the lower end of which a cylindrical shell (15) is embodied at an angle of 90° to the geometrical axis (X₁-axis) of the coupling bolt (12). A rotating cylindrical piece (16) is arranged in the shell (15), with a block (17), embodied on the free peripheral section thereof, with pins (18) for electrical connections and at least two hollow guide bolts (19) for pneumatic and mechanical connection with a bush piece (22), projecting from the trailer, arranged on the free front face thereof. The bush piece (22) is arranged below the drawbar (20) such as to rotate about two axes (Y₂ and X₂), perpendicular to each other and is provided with bushes (23), for accommodating the pins (18) and bushes (24) for accommodating the guide bolts (19).

The invention relates to a coupling device for the coupling of a trailer vehicle to a tractor, comprising, on the tractor, a coupling body with an insertion opening and pneumatically operable coupling bolt, and, on the trailer, a drawbar with a drawbar eye for the passage of the coupling bolt.

There are known so-called trailer couplings, wherein the eye of the drawbar is inserted into the insertion opening of the coupling body and the coupling bolt is operated pneumatically thereafter such that it is located in the coupled condition inside of the eye of the trailer. However, with such a coupling electrical and pneumatic connections must be established by hand, in order to be able for example to perform the braking and vehicle direction indications in controlled manner and to operate the brakes.

The present invention is intended to provide a coupling of the type indicated above, in which it is not required any more that any connecting processes must be performed manually and that both, when a trailer is to be coupled and a trailer is to be uncoupled.

This is achieved by the features given in the characterising parts of the patent claims, namely that, below the coupling body, a tubular piece is arranged, which is coaxially rotatable with regard the geometrical axis (Z-axis) of the coupling bolt, at the lower end of which a cylindrical half shell is formed at an angle of 90° to the geometrical axis (X₁-axis) of the coupling bolt,

a cylindrical part is arranged in the half shell coaxially accommodated therein and coaxially (axis X₁) rotatable thereto, with a block formed on the free peripheral section thereof, with pins for electrical connections as well as at least two hollow guide bolts for pneumatic and mechanical connection with a bush part projecting from the trailer arranged on the free front face thereof, and

the bush part is arranged below the drawbar flexibly connected therewith swivelling about two axes (Y₂ and X₂) perpendicular to each other, and is provided with bushes for accommodating the pins and bushes for accommodating the guide bolts.

In one embodiment of the invention an intermediate piece is movably arranged, which comprises passages for the pins.

Furthermore, the bush part can be hinged swivelling around its longitudinal axis (X₂) in transverse direction to the drawbar and around its transverse axis (Y₂) parallel to the drawbar.

In the coupling device the coupling and uncoupling operation can be performed from the driver's cabin, without any outside operations being necessary. This is achieved substantially in that both at the coupling housing and at the drawbar co-operating bush plug connections are provided, which can be connected with each other electrically as well as pneumatically. Since it usually cannot be assumed that the trailer vehicle is aligned in the driving direction towards the tractor, the respective coupling elements must be arranged such that they can accommodate misalignments. Therefore, the plug part at the tractor as well as the bush part at the trailer vehicle are moveable in multiple axes. It is obvious that the plugs can be arranged in corresponding manner at the trailer vehicle and the bushes correspondingly at the tractor.

The invention is illustrated below by way of example with reference to the drawing.

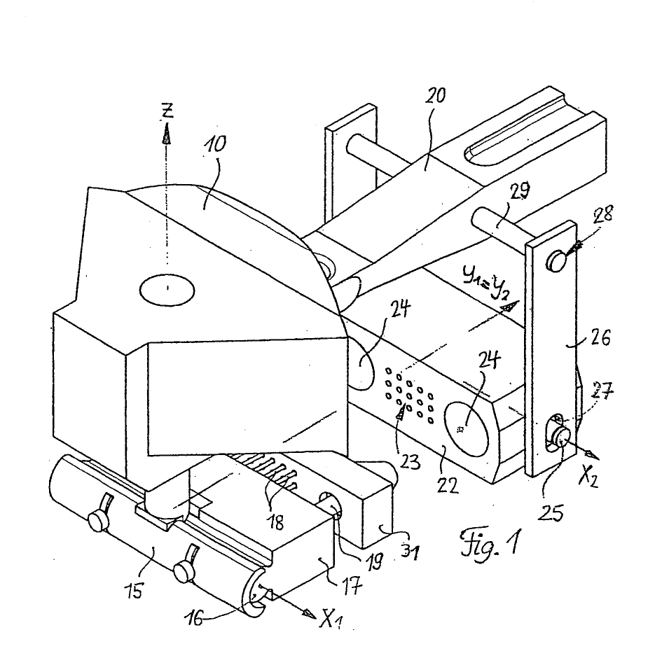

FIG. 1 shows an isometric illustration of the parts of the coupling according to the invention just before a coupling process.

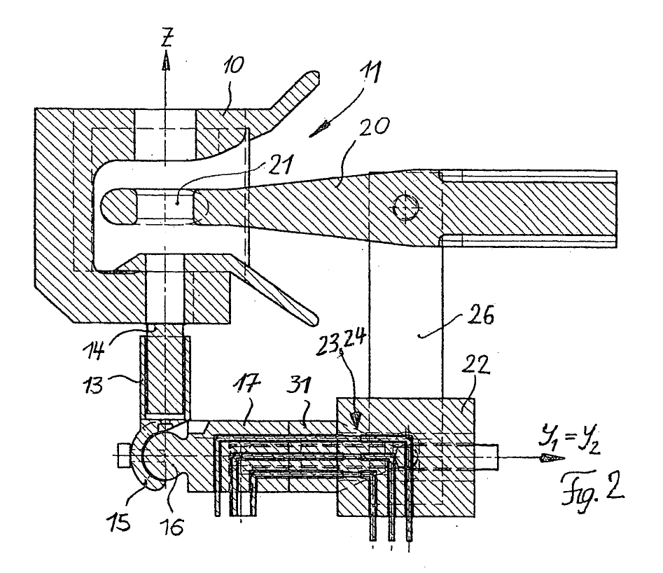

FIG. 2 shows, in altered scale, a vertical sectional view through the coupling device according to the invention.

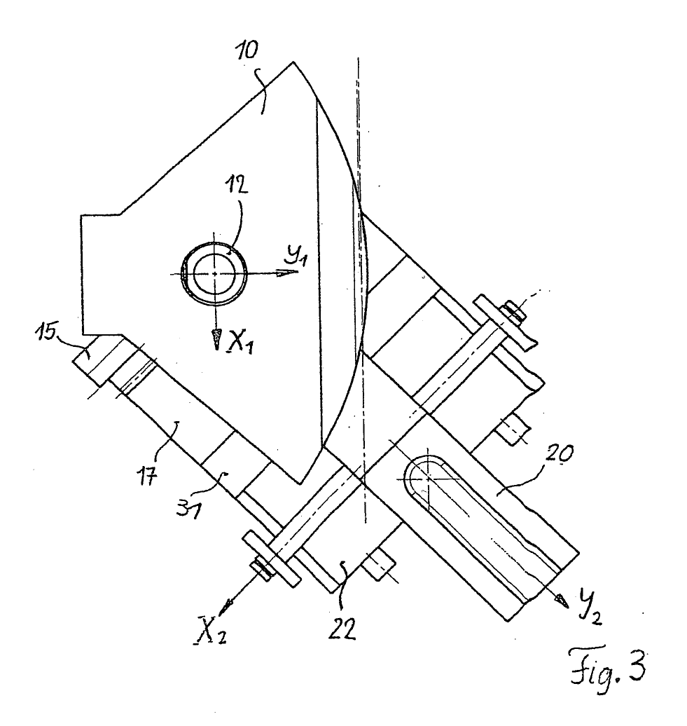

FIG. 3 shows a plan view onto the coupling device, wherein trailer vehicle and tractor are not aligned with each other.

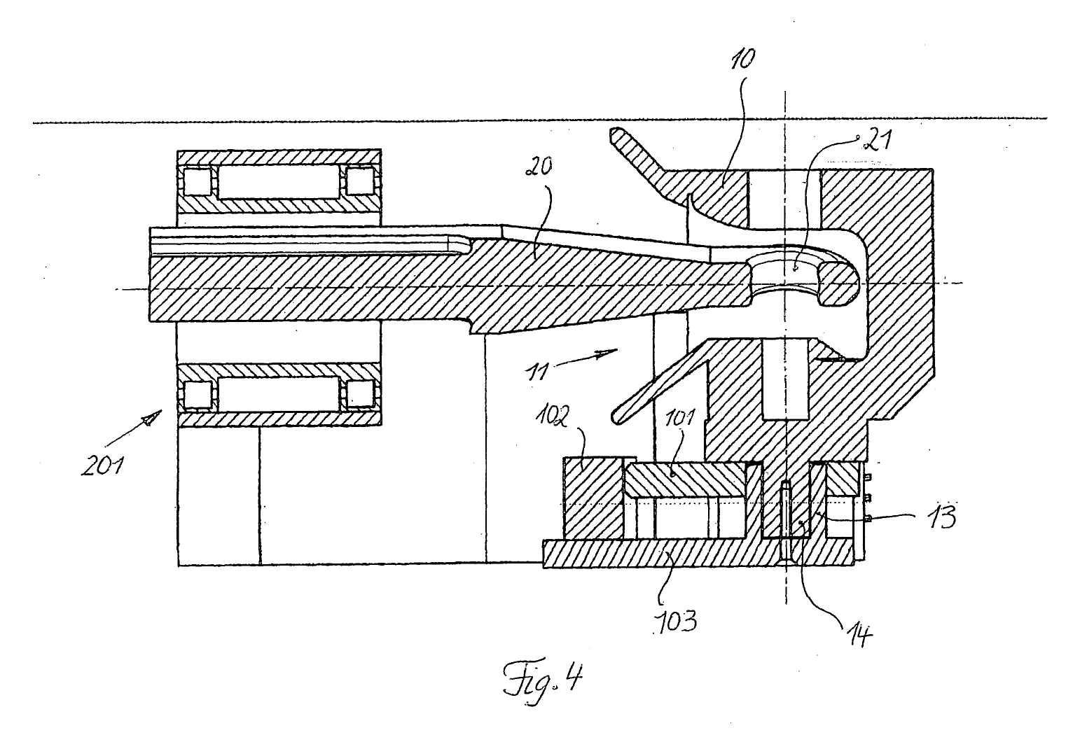

FIG. 4 shows a vertical sectional view through the coupling body, the insertion opening and the drawbar of a modified embodiment of the invention.

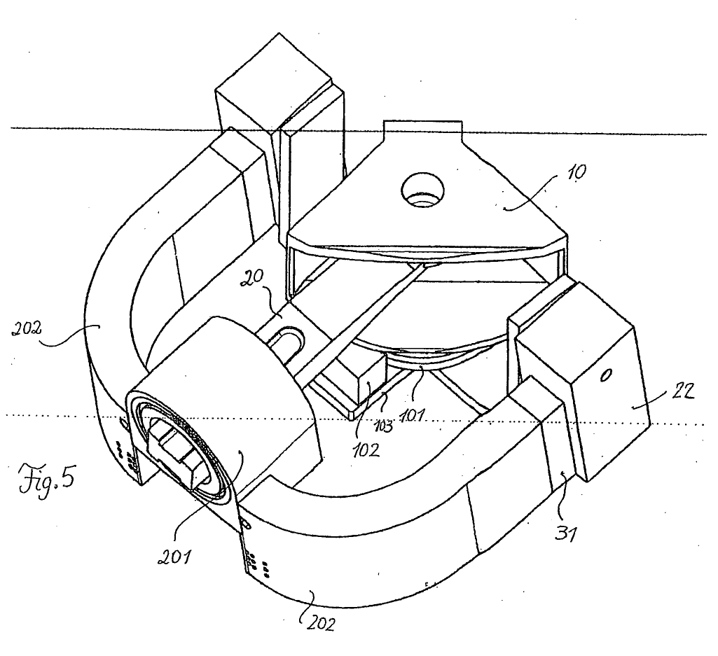

FIG. 5 shows a diagrammatic view of the parts shown in FIG. 4 obliquely from above.

In the figures, 10 indicates the coupling body formed in known manner with an insertion opening 11 for reception of a drawbar 20 with a drawbar eye 21. The ideal relationships of the mutual arrangements of these parts can be taken from FIG. 2, wherein it can be assumed that this condition does hardly occur in practice, because, on the one hand, the tractor and the trailer vehicle are not aligned in a common direction, in the driving direction. On the other hand, the road is usually not plane such that the drawbar eye 21 is tilted from the horizontal plane.

In the figures, the vertical geometrical axis of a tension bolt recognisable in the elevation according to FIG. 3 and having the reference number 12, has been indicated as Z. The associated perpendicular direction corresponding to the driving direction of the tractor has been indicated as Y₁. The transverse direction to the driving direction of the tractor has been indicated as X₁, such that a spatial trihedral can be recognised from FIG. 1 consisting of X₁, Y₁ and Z.

Below the coupling body 10 a pivot 14 projects coaxially downwards to the Z-axis or to the axis of the coupling bolt 12, respectively. A tube or tubular piece 13 sits on this pivot 14 such that this can perform rotary motions around the Z-axis or the longitudinal axis of the coupling bolt 12, respectively. The tubular piece 13 terminates in the lower area with a half shell part 15, the interior of the half shell 15 extending perpendicularly to the Z-axis, i.e. is oriented towards the axis X₁ extending transversely to the driving direction of the tractor.

A cylindrical part 16 is received in the half shell 15 such that it can implement rotary or swivelling motions around its longitudinal axis X₁. In the FIGS. 1 and 2 slots can be recognised in the shell 15, through which the screws connected with the cylindrical part 16 pass, such that the cylindrical part 16 is securely accommodated in the interior of the shell part 15, but both parts can swivel with regard to each other.

At its free front face and substantially in backward direction, that is aligned towards the axis Y₁, a block 17 is mounted at this partial cylinder 16, which substantially comprises the shape of a cuboid. Inside of this block 17 electrical as well as pneumatic connecting lines are located. A plurality of plug pins 17 project from the front face of the block 17 directed backwards, which can form electrical connections with the bushes 23. Furthermore, hollow bolts 19 project from the front face 2, which can co-operate with receiving parts 24 in the bush part 22.

The hollow bolts 19 are connected internally with a compressed air source such that they can transfer in the coupled condition compressed air from the tractor to the trailer vehicle in order to operate and release the brakes.

Two sliding pieces or intermediate pieces 31 are attached on the hollow bolts 19, which are reciprocal towards the axis Y₁ and are intended to facilitate the process for insertion of the plug 18 and of the hollow bolts 19 into the associated bushes 23 and 24.

Two pins or pivots 29 are fixed diametrically with regard to each other at the outwardly standing end of the drawbar 20, and that in transverse direction with regard to the geometrical axis of the drawbar. This direction of the drawbar 20 is indicated as Y₂. In the properly coupled condition, the axis Y₁ coincides with the axis Y₂, otherwise the drawbar 20 can assume any other direction, of course.

Rods 26 directed downwards to both sides are attached on the pivot 29, which can perform swivelling motions around the axis 28 of the pivots 29.

A longitudinal hole 27 is located at each lower free end of the rods 26, wherein two pivots 25 are received in these longitudinal holes projecting towards the two small side rims of the bush part 22 therefrom. The axis of the pivots 25 is indicated as X₂, said axis X₂ being aligned in parallel with the axis X₁, when the coupling process has been finished.

By arranging the pivots 25 inside of the longitudinal holes 27, it is possible that the bush part 22 performs swivelling motions around its transverse axis Y₂ and rotary motions around its axis X₂.

Thus, the coupling process is performed such that the drawbar 20 is inserted into the insertion opening 11 (FIG. 2). In this process the parts 17 and 31 of the tractor together approach the bush part 22. Since the hollow bolts 19 project the furthest from the block 17 towards Y₁, they first get into the associated bushes 24 of the bush part 23. It can be seen in FIG. 1 that the hollow bolt 19 shown therein is provided with a conical shape to facilitate this insertion process. In a further movement of the block 17 with the intermediate piece 31 towards the bush part 22, a series of correcting operations can be performed. Thus, the block 17 and the intermediate piece 31 can perform rotary motions around the Z-axis and around the axis X₁. Simultaneously, the block 23 can perform swivelling motions around its axes Y₂ and X₂ such that finally the condition shown in section in FIG. 2 can be reached. As the parts coupling bodies and the parts 17 and 31 are flexibly connected with regard to each other, and as the bush body 22 is also flexibly arranged with regard to the rods 26 and thus with regard to the drawbar 20, the drawbar 20 can also bear onto the lower surface of the insertion opening 11 and the square shown in FIG. 2 can modify to a parallelogram, without any mechanical stresses occurring or without any negative influences on the implemented electrical and pneumatic line connections.

Not shown in the figures are final position sensors or switches reporting the condition shown in FIG. 2 to the driver's cabin such that the electrical connections can be connected through from there and for example the brakes can be subject to compressed air.

In FIG. 3 the plan view onto the coupling in the coupled conditions can be seen, and that for the case that a substantial misalignment between the driving direction of the tractor (Y₁-axis) and the alignment of the drawbar 20 (axis Y₂) exists. Also this condition is not problematic with regard to the electrical and pneumatic and mechanical coupling connections. However, it is of special importance for the vehicle driver in the automatic coupling process, to know this angle of misalignment in order to initiate respective starting processes. For this purpose an angle indication can be arranged below the coupling body 10 and the tubular piece 13. Looking at FIG. 2, it can be seen that at this place the angle between these parts can be detected as rotational displacement around the Z-axis and can be transferred into the driver's cabin in digital form such that the driver performs the respective correcting movement either by hand, or this rotational displacement between trailer vehicle and tractor is independently detected by a respective vehicle control.

It is pointed out that this misalignment between drawbar and tractor can be in the range of ±45°, while the other mentioned rotary or swivelling motions are in the range of less than ±25°.

The embodiment of the invention shown in FIG. 4 and FIG. 5 shows details of the suspension of parts to be connected with each other on the drawbar 20. The reference numbers used up to now have been chosen there for the same parts as well.

A rotary body 201 is set onto the drawbar 20, which can perform rotary motions around and concentric with the axis of the drawbar. For this it is only required, to set a bush-like part resisting rotation onto the drawbar, onto which in turn a concentrically arranged part is rotatably mounted. This concentrically arranged part 201 is provided with two arms 202 projecting initially radially outwards from the outer circumference of the part 201 and then merging arc-shaped into parts aligned substantially axial-parallel. These axially aligned parts are aligned at their free projecting ends with the usual coupling connections, which have been indicated for example in FIG. 2 with 17, 31, 22 as well as 23 and 24.

Substantial for the functioning of the parts 201 and 202 is that a coupling of the parts 31 with the parts 22 is possible, and that also in the case, when the drawbar 20 is twisted around its axis in one or the other direction. This situation occurs, when the trailer vehicle does not stand on a plane surface, but the one side is elevated with regard to the other vehicle side.

The parts 202 could for example be mounted swivelling at the bush 201 by means of a pivot, or the parts 22 could be swivelling through a common horizontal axis extending in transverse direction to the tractor. Based on this Cardan's suspension a compensating process can occur here.

It is shown in FIG. 4 as well, in which manner the angular position can be detected, that is when the trailer vehicle and the tractor are not in a straight position to each other during coupling. This situation can be recognised in FIG. 5, which shows that the tractor with the insertion coupling 10 is at an angle to the axis of the drawbar 20. This situation arises in that the tractor has not been or cannot be brought into the aligned position before the coupling process, because the approach way is blocked by a different vehicle.

It can be seen from FIG. 4 that a bush 13 is rotatably attached on the downward extending projection 14 of the coupling body 10, which is rotatable around the axis Z of the insertion coupling 10. A radial projecting part 103 is attached to the bush 13, and a box-shaped sensor head 102 with Hall sensors is arranged thereon.

A disk 101 is attached to the coupling body 10, at the outer circumference of which magnetic traces, preferably in form of a gray code, are arranged. Since the disk 101 assumes a fixed position with regard to the coupling body 10, and since the sensor head 102 can be twisted relatively to the axis of the coupling body 10, it is obvious that by means of the Hall sensors and the magnetic traces the angle of the misalignment can be detected, wherein this is the angle between the longitudinal vehicle axis of the tractor and the axis of the tractor drawbar. This angle is of importance for starting processes after the coupling process and that especially, when this starting process is to be performed independently.

1. A coupling device for the coupling of a trailer vehicle to a tractor, comprising, on the tractor, a coupling body (10) with an insertion opening (11) and a pneumatically operable coupling bolt (12) and, on the trailer, a drawbar (20) with a drawbar eye (21) for the passage of the coupling bolt (12), characterized in that, below the coupling body (10), a tubular piece (13) is arranged, which is coaxially rotatable with regard to the geometrical axis (Z-axis) of the coupling bolt (12), and at the lower end of which a cylindrical half shell (15) is formed at an angle of 90° to the geometrical axis (X₁ axis) of the coupling bolt,
a cylindrical part (16) is arranged in the half shell (15) coaxially accommodated therein and coaxially (axis X₁) rotatable thereto, with a block (17) formed at the free peripheral section thereof, with pins (18) for electrical connections as well as at least two hollow guide bolts (19) for pneumatic and mechanical connection with a bush part (22) projecting from the trailer arranged at the free front face thereof and
the bush part (22) is arranged below the drawbar (20) and flexibly connected therewith swivelling around two axes (Y₂ and X₂) perpendicular to each other, and is provided with bushes (23) for accommodating the pins (18) and bushes (24) for accommodating the guide bolts (19).

2. The coupling device according to claim 1, characterized in that on the guide bolts (19) an intermediate piece (31) is movably arranged, in that on the guide bolts (19) an intermediate piece (31) is movably arranged, which comprises passages for the pins (18).

3. A coupling device according to claim 2, characterized in that the bush part (23) is hinged swivelling around its longitudinal axis (X₂) in a transverse direction to the drawbar (20) and around its transverse axis (Y₂) parallel to the drawbar.

4. A coupling device according to claim 3, characterized in that the bush part (23) is hinged swivelling around its longitudinal axis (X₂) in a transverse direction to the drawbar (20) and around its transverse axis (Y₂) parallel to the drawbar.
